(19) United States
(12) Patent Application Publication
(10) Pub. No.: US 2012/0174268 A1
(43) Pub. Date: Jul. 5, 2012

(54) ASSEMBLY OF MICROCANTILEVER-BASED SENSORS WITH ENHANCED DEFLECTIONS

(75) Inventors: Kambiz Vafai, Mission Viejo, CA (US); Abdul Rahlm A. Khaled, Jeddah (SA)

(73) Assignee: Kambix Innovations, LLC.

(21) Appl. No.: 13/247,169

(22) Filed: Sep. 28, 2011

Related U.S. Application Data
(60) Provisional application No. 61/429,234, filed on Jan. 3, 2011.

(51) Int. Cl. G01Q 70/08; G01Q 70/16

(52) U.S. Cl. 850/56; 850/60

(57) ABSTRACT

An assembly of microcantilever-based sensors with enhanced deflections. A deflection profile of an ε-assembly can be compared with that of a rectangular microcantilever and a modified triangular microcantilever. Various force-loading conditions can also be considered. A theorem of linear elasticity for thin beams is utilized to obtain the deflections. The obtained defections can be validated against an accurate numerical solution utilizing a finite element method with a maximum deviation of less than 10 percent. The ε-assembly produces larger deflections than the rectangular microcantilever under the same base surface stress and same extension length. Also, the ε-microcantilever assembly produces a larger deflection than a modified triangular microcantilever. The deflection enhancement increases as the ε-assembly's free length decreases for various types of force loading conditions. The ε-microcantilever can be utilized in microsensing applications to provide a favorable high detection capability with a reduced susceptibility to external noises.

### CROSS-REFERENCE TO PROVISIONAL PATENT APPLICATION

This application claims priority to U.S. Provisional Patent Application Ser. No. 61/429,234, entitled “Assembly of Microcantilevers Based Sensors with Enhanced Deflections,” which was filed on Jan. 3, 2011, the disclosure of which is incorporated herein by reference in its entirety.

### FIELD OF THE INVENTION

Embodiments are generally related to microsensors. Embodiments also relate to the field of microcantilevers based microsensors. Embodiments additionally relate to assembly of epsilon-shaped microcantilevers based sensors with enhanced deflections.

### BACKGROUND OF THE INVENTION

The rapid growth of nanotechnology has led to developments of new sensing devices of micrometer size coined as microsensors. These devices can be used to detect, measure, analyze, and economically monitor low concentrations of chemical and biological agents. The monitoring of a specific substance is pivotal in many applications especially for clinical purposes. This is in order to screen a patient for the presence of a disease at an early stage. Microcantilevers based microsensors have been proven to be very sensitive and accurate. See, for example, Wu G, Ji H, Hansen K, Thundat T, Datar R, Cote R, Hagan M F, Chakraborty A K and Majumdar A (2001), Origin of Nanomechanical cantilever motion generated from biomolecular interactions PNAS 98:1560-1564. The changes in the physical properties of the microcantilever are considered to indicate or detect changes in the environment surrounding it. The most often considered physical property is the deflection. The deflection of the microcantilever was first used for atomic force microscopy. However, it is mainly used to indicate the presence or absence of a certain analyte. See Akamine S, Barrett R. C. and Quate C. F. (1990), Improved atomic force microscope images using microcantilevers with sharp tips, Appl. Phys. Lett. 57:316 and Raiteri R, Nelles G, Butt H-J, Knoll W and Skladal P (1999), Sensing of biological substances based on the bending of the microfabricated cantilevers, Sens. Actuators B 61:213-217.

The magnitude of microcantilever deflection is of the order of nanometers and it is usually measured using an optical method. The performance of the microcantilever as a sensing device is affected by the noise level in the surrounding environment. For example, Raiteri R, Nelles G, Butt H-J, Knoll W and Skladal P (1999), Sensing of biological substances based on the bending of the microfabricated cantilevers, Sens. Actuators, B 61 213-217 reported that the microcantilever deflection due to flow disturbances and due to thermal effects could reach 5-10 times that due to analyte sensing.

Therefore, a need exists for further developments in microcantilever technology in order to magnify the deflection signal due to the sensing effect so that its signal can be easily distinguished from the noise signal. See Fritz J, Bailer M K, Lang H P, Rothuizen H, Vettiger P, Meyer E, Guntherodt H-J, Gerber Ch and Gimzewski J K 2000, Translating biomolecular recognition into nanomechanics, Science 288 316-8, Yang M, Zhang X, Vafai K and Ozkan C S 2003, High sensitivity piezoresistive cantilever design and optimization for an analyte-receptor binding, J. Micromech. Microeng. 13 864-72, and Khaled A.-R. A. and Vafai, K. 2004, Optimization modeling of analyte adhesion over an inclined microcantilever-based biosensor, J. Micromech. Microeng. 14 1220-29. As such, Khaled A-R A, Vafai K, Yang M, Zhang X and Ozkan C S 2003, Analysis, control and augmentation of microcantilever deflections in bio-sensing systems, Sens. Actuators B 94 103-115, pointed out the necessity of establishing special microcantilevers assemblies for this purpose.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for microsensors.

It is another aspect of the disclosed embodiments to provide for microcantilever-based microsensors.

It is yet another aspect of the disclosed embodiments to provide for an assembly of microcantilever-based sensors with enhanced deflections.

The aforementioned aspects and other objectives and advantages can now be achieved as described herein. In general, microcantilever assemblies including an ε-assembly configuration can be utilized to provide for microcantilever-based sensors and related components. Various force loading conditions that can produce noticeable deflections such as the concentrated force, moment, and constant surface stress which can be due to analyte adhesion are considered, as discussed in greater detail herein. The linear elasticity theory for thin beams can be utilized to obtain the deflections. Different deflection indicators are defined and various controlling variables are identified. The performances of different microcantilever assemblies are compared with the performance of rectangular microcantilevers in order to map out conditions that produce magnification of the sensing deflection relative to the noise deflection.

The deflection profile of an ε-assembly can be compared with that of the rectangular microcantilever and modified triangular microcantilever. Various force-loading conditions are considered. A theorem of linear elasticity for thin beams can be employed to obtain the deflections. The obtained defections can be validated against an accurate numerical solution utilizing a finite element method with maximum deviation less than, for example, 10 percent. In general, the ε-assembly can produce larger deflections than a rectangular microcantilever under the same base surface stress and same extension length. In addition, the ε-microcantilever assembly can produce a larger deflection than the modified triangular microcantilever. This deflection enhancement is found to increase as the ε-assembly's free length decreases for various types of force loading conditions. Consequently, the ε-microcantilever can be employed in microsensing applications as it provides favorable high detection capability with a reduced susceptibility to external noises.

Varying embodiments are disclosed. For example, in an embodiment, an apparatus can be configured, which includes an assembly of epsilon-shaped microcantilever based sensors with enhanced deflection. Such an apparatus can include, for example, a first side beam, a second side beam, and an intermediate beam, wherein the first side beam, the second side beam, and the intermediate beam are force loaded utilizing varying force loadings including at least one of a concentrated force, a concentrated moment, and a constant surface stress, wherein an effect of the varying force loadings is to produce rotations of the intermediate beam that are in a same direction of rotations of the first side beam and the second side beam, and a receptor coated on top surfaces of the first and second side beams and on a bottom surface of the intermediate beam. In another embodiment, such an apparatus can include a deflection profile of the assembly that is larger than that of a rectangular microcantilever and a modified triangular microcantilever.

In yet another embodiment, a method can be provided for forming an assembly of epsilon-shaped microcantilever based sensors with enhanced deflection. Such a method can include the steps of, for example, providing a first side beam, a second side beam and an intermediate beam; force loading the first side beam, the second side beam and the intermediate beam utilizing varying force loadings including at least one of a concentrated force, a concentrated moment and a constant surface stress, wherein an effect of the varying force loadings is to produce rotations of the intermediate beam that are in a same direction of rotation of the first side beam and the second side beam; and coating a receptor on top surfaces of the first and second side beams and on a bottom surface of the intermediate beam. In still another embodiment, a step can be implemented for providing a deflection profile of the assembly that is larger than that of a rectangular microcantilever and a modified triangular microcantilever.

### DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1A is a schematic diagram and the coordinate system of rectangular microcantilever, in accordance with the disclosed embodiments;

FIG. 1B is a schematic diagram and the coordinate system of modified triangular microcantilever assembly, in accordance with the disclosed embodiments;

FIG. 1C is a schematic diagram and the coordinate system of ε-microcantilever assembly, in accordance with the disclosed embodiments;

FIG. 2 illustrates a graph illustrating the deflection profile for ε-microcantilever assembly using numerical solutions with L=385 μm, W=30 μm, t=20 nm, M=10⁻¹² Nμm, E=0.185 Nμm⁻² and ν=0.33, in accordance with the disclosed embodiments;

FIG. 3 illustrates a graph illustrating the effects of the relative dimensions of the modified triangular microcantilever and ε-microcantilever assemblies on the first performance indicators γ_{bF} and γ_{cF}, in accordance with the disclosed embodiments;

FIG. 4 illustrates a graph illustrating the effects of the relative dimensions of the modified triangular microcantilever and ε-microcantilever assemblies on the first performance indicators γ_{bM} and γ_{cM}, in accordance with the disclosed embodiments;

FIG. 5 illustrates a graph illustrating the effects of the relative dimensions of the modified triangular microcantilever and ε-microcantilever assemblies on the first performance indicators γ_{bΔσ} and γ_{cΔσ}, in accordance with the disclosed embodiments;

FIG. 6 illustrates a graph illustrating the effects of the relative dimensions of the modified triangular microcantilever and ε-microcantilever assemblies on the second performance indicators λ_{cF}, in accordance with the disclosed embodiments;

FIG. 7 illustrates a graph illustrating the effects of the relative dimensions of the modified triangular microcantilever and ε-microcantilever assemblies on the second performance indicators λ_{cM}, in accordance with the disclosed embodiments; and

FIG. 8 illustrates a graph illustrating the effects of the relative dimensions of the modified triangular microcantilever and ε-microcantilever assemblies on the second performance indicators λ_{cΔσ}, in accordance with the disclosed embodiments.

### DETAILED DESCRIPTION OF THE INVENTION

The particular values and configurations discussed in these non-limiting examples can be varied and are cited merely to illustrate at least one embodiment and are not intended to limit the scope thereof.

The following Table 1 provides the various symbols and meanings used in this invention:

TABLE 1
Nomenclature:

| | |
|---|---|
| B | Base length of the microcantilever assembly |
| E | Elastic modulus (N μm⁻²) |
| F | concentrated force (N) |
| I | Area moment of inertia (μm⁴) |
| L | microcantilever or assembly extension length (μm) |
| M | moment (N μm) |
| n | surface stress model index |
| t | microcantilever thickness (μm) |
| W | microcantilever width (μm) |
| x | axis of the extension dimension (μm) |
| Y | effective elastic modulus (N μm⁻²) |
| z | deflection (μm) |

Greek symbols:

| | |
|---|---|
| γ | first deflection indicator |
| λ | second deflection indicator |
| ν | Poisson's ratio |
| σ | surface stress |

Subscripts:

| | |
|---|---|
| F | concentrated force condition |
| M | moment condition |
| Δσ | constant differential surface stress condition |

Abbreviations:

| | |
|---|---|
| IB | the intermediate beam of ε-assembly |
| SB | the side beams of ε-assembly |

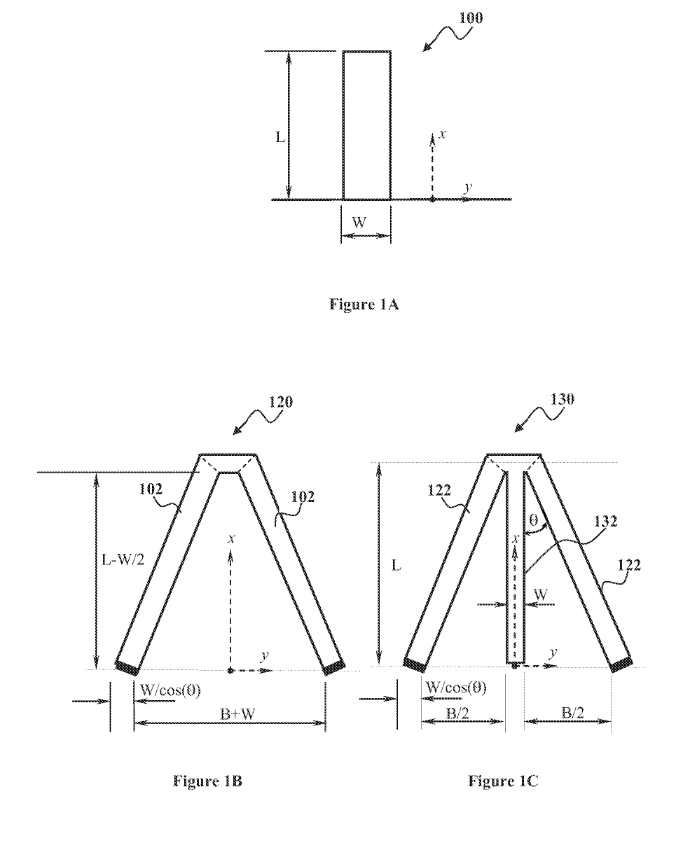

The geometry of a rectangular microcantilever 100 is depicted in FIG. 1A. Specifying, for example, the extension length L, width W, thickness t, Young's modulus E, and Poisson's ratio can summarize the properties of the rectangular microcantilever 100. When the length of the microcantilever 100 is much larger than its width, Hooks law for small deflections can be used to relate the microcantilever 100 deflections to the effective elastic modulus Y and the bending moment M [9]. It is given by:

$$\frac{{d}^{2} z}{d {x}^{2}} = \frac{M}{YI} \qquad Eq . 1$$

wherein z is the deflection of the microcantilever 100 at any section located at a position x from the base surface. I is the area moment of inertia of the microcantilever cross-section about its neutral axis. For a rectangular cross-section with its neutral axis coinciding with its centroidal axis, I is given by:

$$I = \frac{I}{I 2} {Wt}^{3} \qquad Eq . 2$$

The boundary conditions for Equation 1 are given by:

$$z ( x = 0 ) = \frac{d z}{d x} {\vert}_{x = 0} = 0 \qquad Eqs . 3 ( a , b )$$

For a concentrated force exerted on the rectangular microcantilever 100 tip (x=L), the solution of Equation 1, denoted by z_{af}(x), subject to boundary conditions given by Equations 3(a, b) can be expressed as:

$${z}_{nF} ( x ) = ( \frac{6 {FL}^{3}}{{EWt}^{3}} ) [ {( \frac{x}{L} )}^{2} - \frac{l}{3} {( \frac{x}{L} )}^{3} ] \qquad Eq . 4$$

The above result is based on a realistic linearly increasing bending moment from the base prescribed by:

$$M = FL ( l - \frac{x}{L} ) \qquad Eq . 5$$

For thin cross-sections, the surface stress, σ, can be calculated from the following equation:

$$σ = \frac{M}{l} ( \frac{t}{2} ) \qquad Eq . 6$$

The surface stress at x=0 (base surface) denoted by σ_{aFo} is equal to:

$${σ}_{aFo} = \frac{6 FL}{{Wt}^{2}} \qquad Eq . 7$$

The maximum deflection which occurs at the microcantilever tip (x=L) can be expressed as:

$${z}_{aF max} = \frac{4 {FL}^{3}}{{EWt}^{3}} \qquad Eq . 8$$

For a bending moment M exerted on the rectangular microcantilever 100 tip (x=L), the solution of Equation 1, denoted by z_{aM}(x), subject to boundary conditions given by Equations 3(a, b) can be expressed as:

$${z}_{aM} ( x ) = ( \frac{6 {ML}^{2}}{{EWt}^{3}} ) {( \frac{x}{L} )}^{2} \qquad Eq . 9$$

The surface stress at the base section which is denoted by σ_{aMo} is equal to:

$${σ}_{aMo} = \frac{6 M}{{Wt}^{2}} \qquad Eq . 10$$

The maximum deflection which is the deflection at the microcantilever 100 tip is equal to:

$${z}_{aM max} = \frac{6 {ML}^{2}}{{EWt}^{3}} \qquad Eq . 11$$

When the microcantilever 100 is coated on one side with a thin film of receptor, it is usually bent due to analyte adhesion on that layer. This adhesion causes a differential in the surface stress across the microcantilever 100 section yielding a bending moment at each section. The bending moment M [1, 8] is given by:

$$M = \frac{Δσ Wt}{2} \qquad Eq . 12$$

wherein Δσ is the difference between the surface stresses of the top and bottom sides of the microcantilever 100. The solution of Eq. 1, denoted by z_{aΔσ}(x), subject to boundary conditions given by Equations 3(a, b) can then be expressed as:

$${z}_{a Δ σ} ( x ) = \frac{6 ( l - v ) {Δσ}_{o} {L}^{2}}{{Et}^{2} ( n + l ) ( n + 2 )} {( \frac{x}{L} )}^{n + 2} \qquad Eq . 13$$

This is because the effective elastic modulus for this case is given by Y=E/(1−v). Also, Δσ is considered to vary along the microcantilever length according to the following relationship:

$$Δσ = {{Δσ}_{o} ( \frac{x}{L} )}^{n} \qquad Eq . 14$$

wherein n is the model index. This variation is expected as analyte concentration in the surrounding environment and is expected to increase as the distance from the microcantilever 100 base increases. The maximum deflection due to analyte adhesion is obtained from Equation 13 by substituting x=L. It is equal to:

$${Z}_{a Δ σ m max} ( x ) = \frac{6 ( 1 - v ) Δ {σ}_{o} {L}^{2}}{{Et}^{2} ( n + 1 ) ( n + 2 )} \qquad Eq . 15$$

Equation 15 can be reducible to the Stoney's equation when n is set to be equal to zero.

The geometry of the modified triangular microcantilever assembly 120 is shown in FIG. 1B. Equation 1 is changeable to the following when the center line of the free end (x=L) is loaded by a normal concentrated force of magnitude F:

$$\frac{{d}^{2} {z}_{bF}}{d {x}^{2}} = ( \frac{3 FL}{{EWt}^{3}} ) \times 2 ( l - x / L ) / {cos}^{3} ( θ ) \qquad Eq . 16$$

Note that I for each beam 102 is I=Wt³/12. Note that θ is half the triangular tip angle. The cosine of the angle θ is given by:

$$cos ( θ ) = {[ 1 + {0.25 [ \frac{B / L}{1 - 0.5 ( W / L )} ]}^{2} ]}^{- 1 / 2} \qquad Eq . 17$$

The boundary conditions for Equation 16 are given by:

$${z}_{b} ( x = 0 ) = \frac{d {z}_{b}}{d x} {\vert}_{x = 0} = 0 \qquad Eqs . 18 ( a , b )$$

The solution of Equation 16, denoted by z_{bF}(x), subject to the above boundary conditions is the following:

$${z}_{bF} ( x ) = ( \frac{3 {FL}^{3}}{{EWt}^{3}} ) [ {( \frac{x}{L} )}^{2} - \frac{1}{3} {( \frac{x}{L} )}^{3} ] ( \frac{1}{{cos}^{3} ( θ )} ) \qquad Eq . 19 ( a )$$

Using Equation 6, the surface stress at x=0, σ_{bFo}, is equal to:

$${σ}_{bFo} = ( \frac{3 FL}{{Wt}^{2}} ) [ \frac{1}{cos ( θ )} ] \qquad Eq . 20$$

The maximum deflection occurs at the tip (x=L). It is equal to:

$${z}_{bFmax} = ( \frac{3 {FL}^{3}}{{EWt}^{3}} ) \{ \frac{2}{3 {cos}^{3} ( θ )} \} \qquad Eq . 21$$

For a bending moment M about x-axis exerted on the center line of the free end of the modified triangular microcantilever assembly 120 (at x=L), Equation 1 is changeable to the following form:

$$\frac{{d}^{3} {z}_{bM}}{d {x}^{2}} = ( \frac{3 M}{{EWt}^{3}} ) \times 2 / cos ( θ ) \qquad Eq . 22$$

The solution of Equation 22, subject to boundary conditions given by Equation 18 (a, b) is the following:

$${z}_{bM} ( x ) = ( \frac{3 {ML}^{3}}{{EWt}^{3}} ) {( \frac{x}{L} )}^{2} [ \frac{1}{cos ( θ )} ] \qquad Eq . 23$$

As such, the maximum deflection is expected to be equal to:

$${z}_{bM max} = ( \frac{3 {ML}^{2}}{{EWt}^{3}} ) \{ \frac{1}{cos ( θ )} \} \qquad Eq . 24$$

Using Equation 6, the surface stress at x=0, σ_{cMo}, is equal to:

$${σ}_{bMo} = 3 \frac{M}{{Wt}^{2}} cos ( θ ) \qquad Eq . 25$$

When a receptor layer is coated on one side of modified triangular microcantilever assembly 120 side beams (SB) 122, Equation 1 changes to the following form after the analyte adhesion on these coatings:

$$\frac{{d}^{2} {z}_{b Δσ}}{d {x}^{2}} = \{ \frac{6 ( 1 - v ) {Δσ}_{o}}{{Et}^{2}} \} \times {( x / L )}^{n} / {cos}^{2} ( θ ) \qquad Eq . 26$$

The solution of Equation 26, subject to boundary conditions given by Equation 18 (a, b) is the following:

$${z}_{b Δ σ} ( x ) = \{ \frac{6 ( 1 - v ) {Δσ}_{o} {L}^{2}}{{Et}^{2} ( n + 1 ) ( n + 2 )} \} {( \frac{x}{L} )}^{n + 2} [ \frac{1}{{cos}^{2} ( θ )} ] \qquad Eq . 27$$

The maximum deflection due to analyte adhesion is then equal to:

$${z}_{b Δ σ m max} = \{ \frac{6 ( 1 - v ) {Δσ}_{o} {L}^{2}}{{Et}^{2}} \} \{ \frac{1 / {cos}^{2} ( θ )}{( n + 1 ) ( n + 2 )} \} \qquad Eq . 28$$

The first deflection indicator γ_{pU} can be defined as the ratio of the microcantilever deflection at the tip (x=L) per surface stress at the base for the microcantilever of type (p) due to force loading of type U to the corresponding value for the rectangular microcantilever 100. The type (p) can be either the microcantilever of type modified triangular microcantilever assembly 120 or microcantilever ε-assembly 130 as shown in FIG. 1B and FIG. 1C. The force loading of type U can be concentrated force loading (F), external bending moment (M) or constant surface stress (Δσₒ). As such, γ_{bF}, γ_{bM} and γ_{bΔσ}, are equal to:

$$\begin{matrix}{γ}_{bF} = 1 / {cos}^{3} ( θ ) & Eq . 29 ( a ) \\ {γ}_{bM} = \frac{1}{{cos}^{2} ( θ )} & Eq . 29 ( b ) \\ {γ}_{b {Δσ}_{o}} = 1 / {cos}^{2} ( θ ) & Eq . 29 ( c )\end{matrix}$$

The geometry of the microcantilever ε-assembly 130 is depicted in FIG. 1C. As shown in FIG. 1C, the centerline of the assembly free end (x=L) can be loaded by a normal concentrated force of magnitude F and the free end of the intermediate beam (IB) 132 can be loaded by the negative of the previous load (−F). Accordingly, Equation 1 changes to the following:

$$\frac{{d}^{2} {z}_{cF}}{d {x}^{2}} = ( \frac{3 FL}{{EWt}^{3}} ) \times [ \begin{matrix}2 / cos ( θ ) , & ( for SB ) \\ - 4 ( x / L ) , & ( for IB )\end{matrix} \qquad Eq . 30$$

wherein SB stands for the side beams 122 and IB stands for the intermediate beam 132 of the assembly 130. The boundary conditions of Equation 30 are given by:

$$\begin{matrix}{{z}_{cSB} ( x = 0 ) = \frac{d {z}_{cSB}}{d x} \vert}_{x = 0} = 0 & Eq . 31 ( a ) \\ {z}_{cSB} ( x = L ) = {z}_{clB} ( x = L ) & Eq . 31 ( b ) \\ {{\frac{d {z}_{cSB}}{d x} \vert}_{x = L} = \frac{d {z}_{clB}}{d x} \vert}_{x = L} & Eq . 31 ( c )\end{matrix}$$

The solution of Equation 30, denoted by z_{cF}(x), is equal to:

$${z}_{cSBF} ( x ) = ( \frac{3 {FL}^{3}}{{EWt}^{3}} ) {( \frac{x}{L} )}^{2} [ \frac{1}{cos ( θ )} ] \qquad Eq . 32 ( a )$$

$${z}_{clBF} ( x ) = ( \frac{3 {FL}^{3}}{{EWt}^{3}} ) \{ - ( \frac{2}{3} ) {( \frac{x}{L} )}^{3} + 2 ( \frac{1}{cos ( θ )} + 1 ) ( \frac{x}{L} ) + {D}_{I} \} \qquad Eq . 32 ( b )$$

wherein D₁ is equal to:

$${D}_{I} = - \{ \frac{1}{cos ( θ )} + \frac{4}{3} \} \qquad Eq . 32 ( c )$$

The surface stress at the base section σ_{cFo} is equal to:

$${σ}_{cF o} = ( \frac{3 FL}{{Wt}^{2}} ) cos ( θ ) \qquad Eq . 33$$

The second deflection indicator λ_{dU} can be defined as the ratio of the IB-free end deflection z_{cIBU}(x=0) to that at the assembly free end z_{cU}(x=L) due to force loading of type U. The force loading of type U can be either the current described force loading (F), external bending moment loading (M) or the constant surface stress (Δσₒ) loading. The last two types of force loadings will be described later on. As such, λ_{cF} is equal to:

$${λ}_{cF} = \frac{{zc}_{dlBF} ( x = 0 )}{{z}_{cF} ( x = L )} = - \{ 1 + \frac{4}{3} cos ( θ ) \} \qquad Eq . 34$$

Now, let a bending moment M be exerted on the microcantilever ε-assembly free end centerline and let another bending moment of same magnitude be exerted on the IB-free end at x=0. The deflection equations for this assembly under the current moments loading is given by the following:

$$\frac{{d}^{2} {z}_{cM}}{d {x}^{2}} = ( \frac{6 M}{{EWt}^{3}} ) \times [ \begin{matrix}2 / cos ( θ ) , & ( for SB ) \\ - 2 , & ( for IB )\end{matrix} \qquad Eq . 35$$

The boundary conditions are given by Equations 31 (a-c). The solution of Equation 35 is given by:

$$\begin{matrix}{z}_{c SBM} ( x ) = \frac{1}{cos ( θ )} ( \frac{6 {ML}^{2}}{{EWt}^{3}} ) {( \frac{x}{L} )}^{2} & Eq . 36 ( a ) \\ {z}_{clBM} ( x ) = ( \frac{6 {ML}^{2}}{{EWt}^{3}} ) \{ - {( \frac{x}{L} )}^{2} + 2 ( \frac{1}{cos ( θ )} + 1 ) ( \frac{x}{L} ) + {D}_{2} \} & Eq . 36 ( b )\end{matrix}$$

wherein D₂ is equal to:

$${D}_{2} = - [ \frac{1}{cos ( θ )} + 1 ] \qquad Eq . 36 ( c )$$

the surface stress at x=0, σ_{cMo}, is equal to:

$${σ}_{cMo} = \frac{6 M}{{Wt}^{2}} cos ( θ ) \qquad Eq . 37$$

The second deflection indicator for microcantilever ε-assembly 130 for the current moments loading λ_{cM} is equal to:

$${λ}_{cM} = \frac{{z}_{clBM} ( x = 0 )}{{z}_{cM} ( x = L )} = - [ cos ( θ ) + 1 ] . \qquad Eq . 38$$

If the top surfaces of the side beams 122 of microcantilever ε-assembly 130 are coated with a receptor while the receptor coating on the intermediate beam 132 is on its bottom surface, then the deflection equations of microcantilever ε-assembly 130 changes to:

$${cos}^{2} ( θ ) \times \frac{{d}^{2} {z}_{cCB Δ σ}}{d {x}^{2}} = - \frac{{d}^{2} {z}_{clB Δ σ}}{d {x}^{2}} = \frac{6 ( 1 - v ) Δ {σ}_{o}}{{Et}^{2}} {( \frac{x}{L} )}^{n} \qquad Eq . 39$$

The solution for Equation 39 subject to boundary conditions given by Equations 31(a-c) is equal to:

$$\begin{matrix} {z}_{cSB Δ σ} ( x ) = \{ \frac{6 ( 1 - v ) Δ {σ}_{o} {L}^{2}}{E ( n + 1 ) {t}^{2}} \} {( \frac{x}{L} )}^{n + 2} \{ \frac{1 / {cos}^{2} ( θ )}{n + 2} \} & Eq . 40 ( a ) \\ {z}_{clB Δ σ} ( x ) = \{ \frac{6 ( 1 - v ) Δ {σ}_{o} {L}^{2}}{E ( n + 1 ) {t}^{2}} \} \{ \frac{- 1}{( n + 2 )} {( \frac{x}{L} )}^{n + 2} + [ 1 + \frac{1}{{cos}^{2} ( θ )} ] [ \frac{x}{L} - \frac{n + 1}{n + 2} ] \} & Eq . 40 ( b )\end{matrix}$$

The deflection indicator for microcantilever ε-assembly 130 due to the alternating analyte adhesion on the surfaces λ_{cΔσ} is equal to:

$${λ}_{c Δ σ} = \frac{{z}_{cl B Δ σ} ( x = 0 )}{{z}_{cSB Δ σ} ( x = L ) } = - ( n + 1 ) [ {cos}^{2} ( θ ) + 1 ] \qquad Eq . 41$$

The deflection indicators γ_{cF}, γ_{cM} and γ_{cΔσ}, can be shown to be equal to the following:

γ_{cF}=1.5/cos²(θ) Eq. 42(a)

γ_{cM}=1/cos²(θ) Eq. 42(b)

γ_{cΔσ}=1/cos²(θ) Eq. 42(c)

The analytical methods discussed herein have been tested against an accurate numerical solution using finite element methods and accounting for all mechanical constraints induced by the assemblies. Among these constraints is restraining the wrapping of the side beams 122 due to the presence of the small connecting beam at x=L.

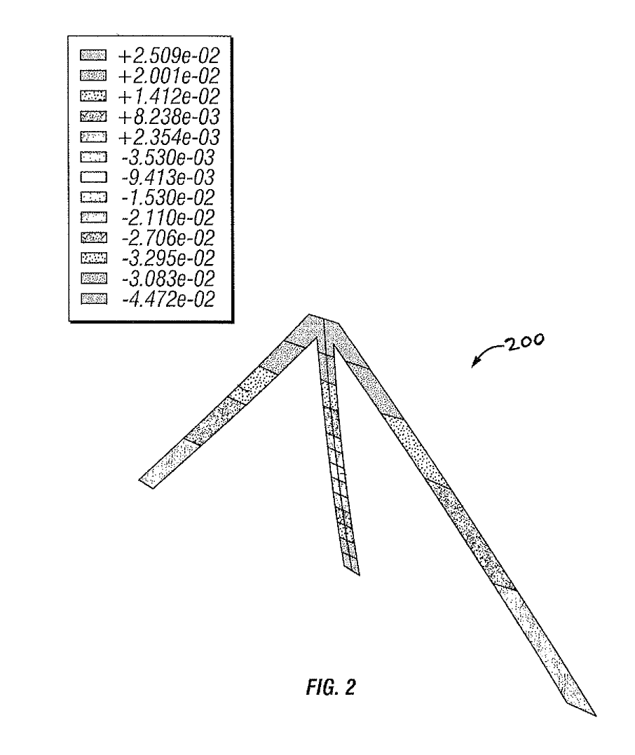

FIG. 2 illustrates a graph 200 illustrating a deflection profile for ε-microcantilever assembly using numerical solutions with L=385 μm, W=30 μm, t=20 nm, M=10-12 Nμm, E=0.185 Nμm-2, and ν=0.33. The microcantilever material was taken to be silicon with E=0.185 Nμm-2 and a poisons ratio of ν=0.33. The assembly deflection at x=L is equal to z_{cM}(x=L)=0.028 μm utilizing Equation 36(b). Also, the deflection at the intermediate beam's free end can be shown to be equal to z_{cIBM} (x=0)=0.048 μm.

As can be seen from FIG. 2, the corresponding numerical values of those deflections are equal to 0.026 μm and 0.045 μm, respectively. Notice that the maximum error between the numerical and the derived analytical solutions is less than 10 percent. Also, notice that the numerical values of deflections are smaller than those predicated by the analytical methods. This is because the geometrical constraints imposed on the assemblies impede the deflections.

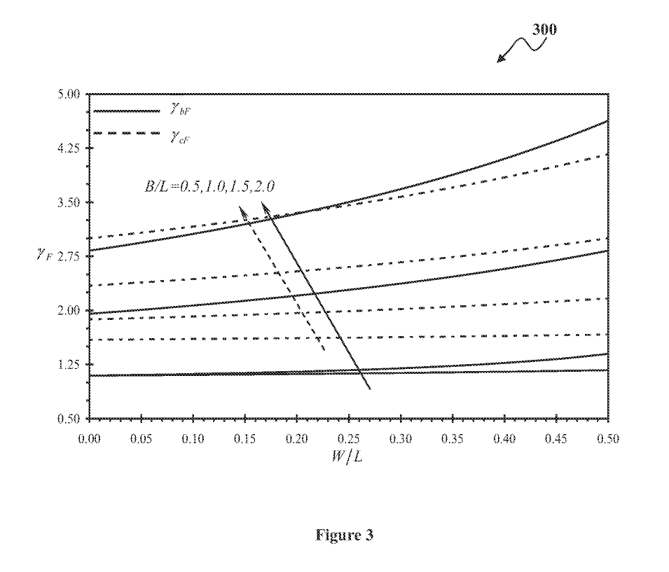

FIG. 3 illustrates a graph 300 illustrating the variation of the performance indicators γ_{bF} and γ_{cF} with the relative dimensions of modified triangular microcantilever assembly 120 and microcantilever ε-assembly 130. It is noticed that all the values of γ_{bF} and γ_{cF} are larger than one which indicates that modified triangular microcantilever assembly 120 and microcantilever ε-assembly 130 produce larger deflections than rectangular microcantilevers 100 under same surface stress at the base and same length L. Moreover, both indicators increase as both the microcantilever width W and the assembly width B increase.

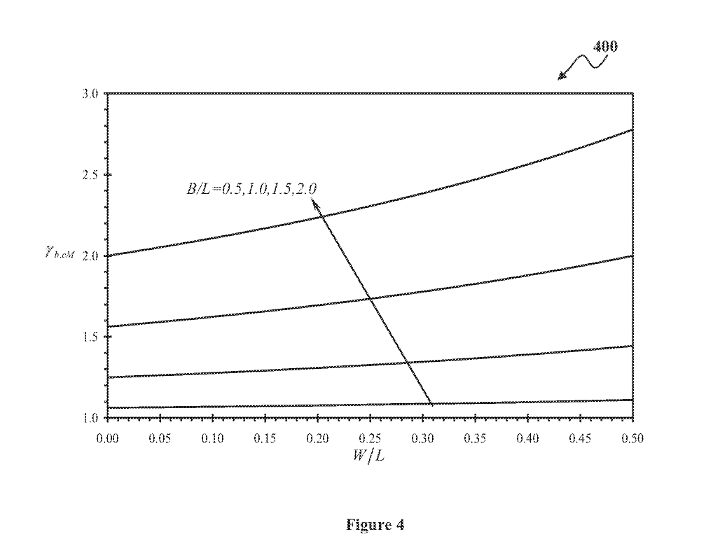

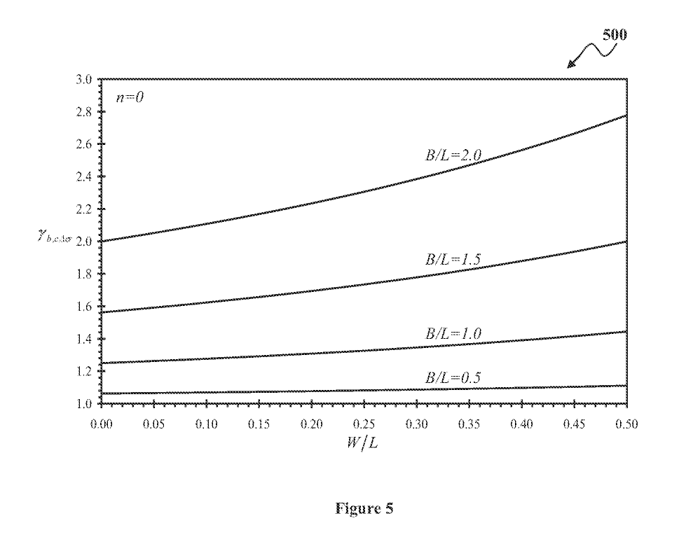

Similar findings are noticed for the performance indicators γ_{bM}, γ_{cM}, γ_{bΔσ}, and γ_{cΔσ} from the graphs 400 and 500 of FIGS. 4 and 5. On the other hand, an increase in B causes the effective free length of the assembly to increase, which makes the assembly more pronounced to external noises.

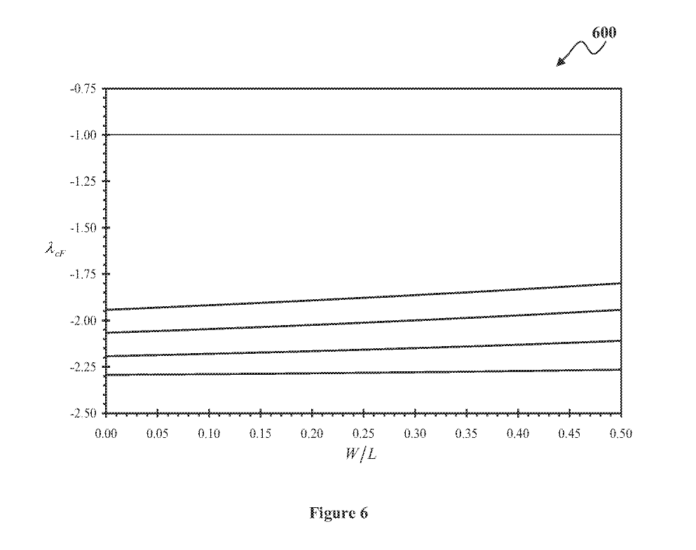

FIG. 6 illustrates a graph 600 illustrating the variation of the second performance indicator λ_{cF} with the relative dimensions of microcantilever ε-assembly 130. It is noticed that all values of λ_{cF} are smaller than minus one. This indicates that IB-free end deflection is always larger than that of the assembly tip deflection. Moreover, the absolute value of λ_{cF} is noticed to increases as both W and B decreases.

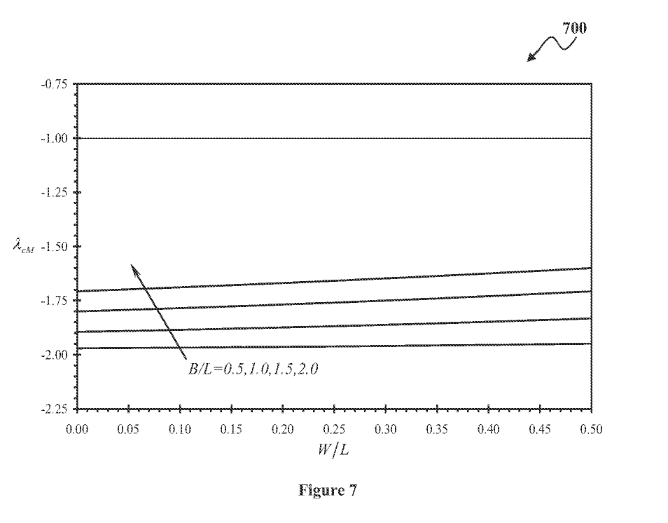

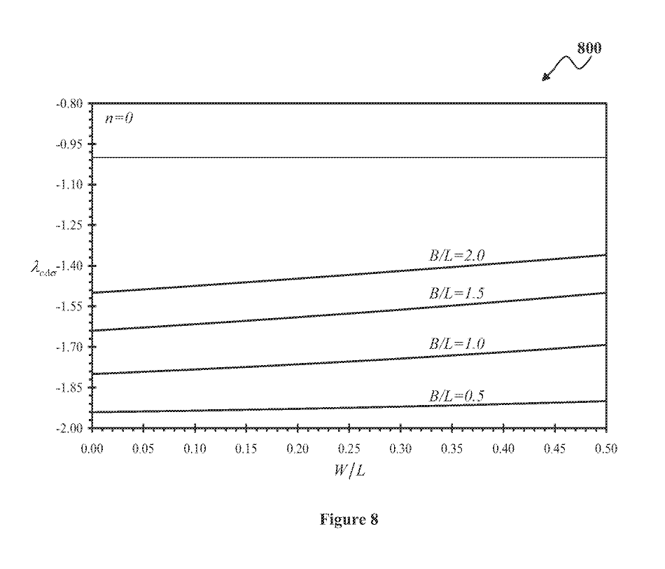

Similar findings are noticed for the performance indicators λ_{cM} and λ_{cΔσ} from the graphs 700 and 800 of FIGS. 7 and 8. As a result, microcantilever ε-assembly 130 can provide larger deflections than modified triangular microcantilever assembly 120 while it is less affected by external noise. This is because its deflection increase as B decreases which results in a reduction of the assembly's free length. Moreover, the absolute values of λ_{cΔσ} increases as n increases as can be shown utilizing Equation 42. This indicates the advantage of microcantilever ε-assembly 130 in microsensing applications as compared to rectangular cantilevers or triangular cantilevers.

An investigation on improving deflections of microcantilevers sensors is presented in this work based on analytical solutions. Three different microcantilevers were analyzed. These are rectangular microcantilever, modified triangular microcantilever assembly, and the ε-microcantilever assembly. The deflection theory of thin beams is utilized to obtain the deflection profile for each microcantilever. Different force loadings were considered including concentrated force, concentrated moment, and constant surface stress. Different deflection indicators were defined and computed. It was found that both the modified triangular microcantilever assembly 120 and the ε-microcantilever assembly 130 produce larger deflections than the rectangular microcantilever 100 under the same base surface stress and same extension length.

In addition, the ε-microcantilever assembly 130 had been found to produce larger deflections than the triangular microcantilever assembly 120. It has also been found that deflection enhancement due to ε-microcantilever increases as the assembly free length decreases. The cited conclusions were found to be valid for the different force loading conditions. The analytical results were validated against an accurate numerical solution utilizing a finite element method. The analytical and numerical solutions have been found to be in good agreement. Based on such analysis, it is believed that the ε-microcantilever assembly provides the best favorable high detection capability with the least susceptibility to external noise in microsensing applications.

Based on the foregoing, it can be appreciated that varying embodiments are disclosed. For example, in one embodiment, an apparatus can be configured, which includes an assembly of epsilon-shaped microcantilever based sensors with enhanced deflection. Such an apparatus can include, for example, a first side beam, a second side beam, and an intermediate beam, wherein the first side beam, the second side beam, and the intermediate beam are force loaded utilizing varying force loadings including at least one of a concentrated force, a concentrated moment, and a constant surface stress, wherein an effect of the varying force loadings is to produce rotations of the intermediate beam that are in a same direction of rotations of the first side beam and the second side beam, and a receptor coated on top surfaces of the first and second side beams and on a bottom surface of the intermediate beam. In another embodiment, such an apparatus can include a deflection profile of the assembly that is larger than that of a rectangular microcantilever and a modified triangular microcantilever.

In another embodiment, a method can be provided for forming an assembly of epsilon-shaped microcantilever based sensors with enhanced deflection. Such a method can include the steps of, for example, providing a first side beam, a second side beam, and an intermediate beam; force loading the first side beam, the second side beam, and the intermediate beam utilizing varying force loadings including at least one of a concentrated force, a concentrated moment, and a constant surface stress, wherein an effect of the varying force loadings is to produce rotations of the intermediate beam that are in a same direction of rotation of the first side beam and the second side beam; and coating a receptor on top surfaces of the first and second side beams and on a bottom surface of the intermediate beam. In another embodiment, a step can be implemented for providing a deflection profile of the assembly that is larger than that of a rectangular microcantilever and a modified triangular microcantilever.

Having thus described exemplary embodiments of the disclosed embodiments, it should be noted by those skilled in the art that the within disclosures are exemplary only and that various other alternatives, adaptations, and modifications may be made within the scope of the embodiments. Accordingly, the embodiments are not limited to the specific embodiments illustrated herein.

What is claimed is:

1. An apparatus comprising an assembly of epsilon-shaped microcantilever based sensors with enhanced deflection, said apparatus comprising:
a first side beam, a second side beam, and an intermediate beam, wherein said first side beam, said second side beam, and said intermediate beam are force loaded utilizing varying force loadings including at least one of a concentrated force, a concentrated moment, and a constant surface stress, wherein an effect of said varying force loadings is to produce rotations of said intermediate beam that are in a same direction of rotation of said first side beam and said second side beam; and
a receptor coated on top surfaces of said first and second side beams and on a bottom surface of said intermediate beam.

2. The apparatus of claim 1 further comprising a deflection profile of said assembly that is larger than that of a rectangular microcantilever and a modified triangular microcantilever.

3. A method for forming an assembly of epsilon-shaped microcantilever based sensors with enhanced deflection, said method comprising:
providing a first side beam, a second side beam, and an intermediate beam;
force loading said first side beam, said second side beam, and said intermediate beam utilizing varying force loadings including at least one of a concentrated force, a concentrated moment, and a constant surface stress, wherein an effect of said varying force loadings is to produce rotations of said intermediate beam that are in a same direction of rotation of said first side beam and said second side beam; and
coating a receptor on top surfaces of said first and second side beams and on a bottom surface of said intermediate beam.

4. The method of claim 3 further comprising providing a deflection profile of said assembly that is larger than that of a rectangular microcantilever and a modified triangular microcantilever.
